(19) United States
(12) Patent Application Publication
(10) Pub. No.: US 2013/0199956 A1
(43) Pub. Date: Aug. 8, 2013

(54) FLEXIBLE PACKAGE AND A METHOD OF MANUFACTURING A FLEXIBLE PACKAGE

(71) Applicants: Adam J. Hunter, Park Ridge, IL (US); William P. Belias, Pittsford, NY (US); Josef F. Vrana, Schaumburg, IL (US)

(72) Inventors: Adam J. Hunter, Park Ridge, IL (US); William P. Belias, Pittsford, NY (US); Josef F. Vrana, Schaumburg, IL (US)

(73) Assignee: WM. Wrigley Jr. Company, Chicago, IL (US)

(21) Appl. No.: 13/823,035

(22) PCT Filed: Sep. 16, 2011
(86) PCT No.: PCT/US11/51956

§ 371 Date: Apr. 22, 2013

Related U.S. Application Data
(60) Provisional application No. 61/384,180, filed on Sep. 17, 2010.

(51) Int. Cl. B65D 25/00; B31B 1/26

(52) U.S. Cl. CPC B65D 25/00; B31B 1/26
USPC 206/459.1; 493/162

(57) ABSTRACT

A resealable package configured to contain a consumable product includes a flexible substrate blank having a flap portion, a back portion and a front portion, wherein the flap portion, the back portion and the front portion are contiguously formed portions of the flexible substrate blank. The package further includes a pocket formed by the cooperation of an inner surface of the front portion and an inner surface of the back portion along a first fold line, and a tamper indicator formed by the cooperation of an inner surface of the flap portion and the outer surface of the front portion on the side of the pocket when the flap portion engages the pocket after being folded along a second fold line.

### PRIORITY DATA

The present patent application is a 371 of International Application Ser. No. PCT/US11/51956 filed 16 Sep. 2011, which claims benefit from Ser. No. 61/384180 filed 17 Sep. 2010, now expired. The applications listed above are incorporated by reference from as if entirely restated herein.

### TECHNICAL FIELD

This patent document generally relates to product packaging, and more particularly to a flexible product packages configured to store and preserve consumable products.

### BACKGROUND

Known product packages are often expensive to manufacture, requiring costly materials or complicated processes. Moreover, these known product packages often require or utilize bulky and/or inconveniently shaped configurations to protect one or more consumable products. Further, many such packages do not include a tamper indicator on the package, but may rely on an additional component, such as an overwrap, to provide a tamper indicator.

It would be desirable to provide a product package that addresses the limitations of known product packages and provides additional advantageous features or elements.

### SUMMARY

The disclosed flexible package and method of manufacturing the flexible package addresses the limitations of the known product packages and advantageously provides mechanisms for tamper indication and usability to facilitate consumer satisfaction.

In a first embodiment, a resealable package configured to contain a consumable product includes a flexible substrate blank having a flap portion, a back portion and a front portion, wherein the flap portion, the back portion and the front portion are contiguously formed portions of the flexible substrate blank. The package further includes a pocket formed by the cooperation of an inner surface of the front portion and an inner surface of the back portion along a first fold line, and a tamper indicator formed by the cooperation of an inner surface of the flap portion and the outer surface of the front portion on the side of the pocket when the flap portion engages the pocket after being folded along a second fold line.

In another embodiment, a method of manufacturing a resealable package configured to contain a consumable product includes: providing a flexible substrate blank having a flap portion, a back portion and a front portion, wherein the flap portion, the back portion and the front portion are contiguously formed portions of the flexible substrate blank; positioning at least one consumable product on an inner surface of the substrate blank such that the at least one consumable product is substantially adjacent to a score line that provides an access panel formed in the front portion; folding the front portion along a first fold line such that the front portion engages the back portion along at least one peripheral edge of the substrate blank; sealing the front portion to the back portion along the peripheral edge to form at least one pocket, wherein the pocket contains the at least one consumable product; and folding the flap portion along a second fold line such that the flap portion engages an outer surface of the pocket, with at least one side section of the flap portion being substantially adjacent to the at least one peripheral edge.

In another embodiment, a resealable package configured to contain a consumable product comprises a) a flexible substrate blank, the flexible substrate blank comprising a front portion, a back portion foldably separated from the front portion by a first fold line, and a flap portion foldably separated from the back portion by a second fold line; b) a pocket configured to contain a plurality of consumable products, the pocket formed by the cooperation of an inner surface of the front portion and an inner surface of the back portion when the front portion is folded along the first fold line to engage the back portion; and c) a tamper indicator formed by the cooperation of an inner surface of the flap portion and marginal areas of the front portion on the side of the pocket when the flap portion engages the pocket after being folded along the second fold line. The tamper indicator is formed by a permanent seal between at least part of the flap portion and at least part of the marginal areas of the front portion. A recloseable seal is provided between the inner surface of the flap portion and the outer surface of the pocket.

Other embodiments are disclosed, and features of each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates a roll of substrate material arranged in a two-up configuration as disclosed herein;

FIG. 2 illustrates a flexible substrate blank configured according to the disclosure provided herein;

FIG. 3 illustrates the flexible substrate blank shown in FIG. 2 supporting a plurality of consumable products;

FIG. 4 illustrates the flexible substrate blank configured to form a pocket;

FIG. 5 illustrates the flexible substrate blank shown in FIG. 2 folded to show a flap portion;

FIG. 6 illustrates an open flexible package where an access panel has been removed via cooperation with the flap portion;

FIG. 7 illustrates a sealed flexible package including a tamper indicator;

FIG. 8 illustrates an open flexible package wherein the tamper indicator has been disturbed; and

FIGS. 9 to 11 illustrate exemplary manufacturing processes that may be implemented in connection with the disclosure provided herein.

FIG. 12 illustrates an inner surface of a flexible substrate blank with a cutout.

FIG. 13 illustrates the inner surface of the flexible substrate blank shown in FIG. 12 with single-sided tape covering the cutout.

FIG. 14 illustrates the outer surface of the flexible substrate blank shown in FIG. 12 including a tamper indicator.

FIG. 15 illustrates an open flexible package wherein the tamper indicator has been disturbed.

### DETAILED DESCRIPTION

The disclosed flexible package and method of manufacturing the flexible package advantageously provides mechanisms for tamper indication and to facilitate consumer usability. The flexible package may be manufactured in a one-up or two-up configuration from, for example, a roll of flexible substrate material, or from individual blanks of flexible substrate material. The flexible package may be folded and sealed to provide a pocket to preserve and present consumable products, such as confectionaries, and particularly chewing gum. The disclosed flexible package provides a low-cost and compact package for handling, selling and accessing consumable products. Moreover, because the flexible package seals and protects consumable products without the need for additional packaging and wrapping, the disclosed flexible package results in little wasted material, thereby making it environmentally friendly compared to many traditional packages.

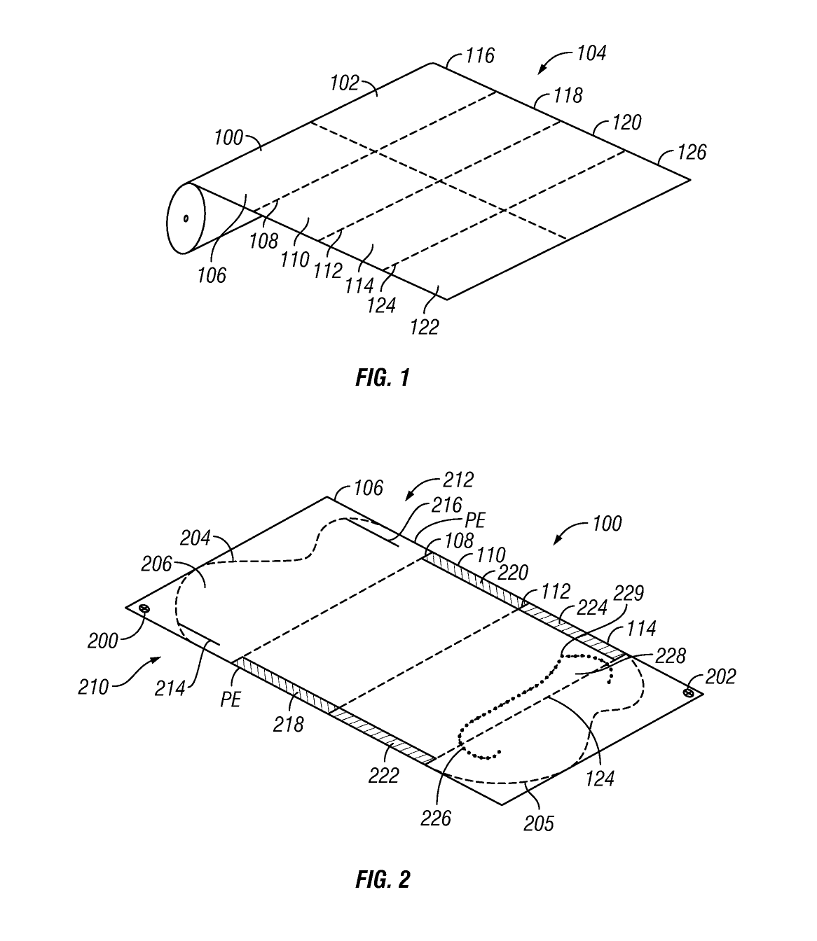

FIG. 1 illustrates a first flexible substrate blank 100 and a second flexible substrate blank 102 formed or cut from a roll of flexible substrate 104. The flexible substrate 104 may be a polypropylene film such as an oriented polypropylene (OPP) material. In one embodiment, the oriented polypropylene material may be a ninety-eight (98) gauge laminated material. In another embodiment, the material may be a seventy (70) gauge metalized oriented polypropylene film, or any other suitable material such as paper, foil, and polyethylene terephthalate (PET) film. The material may further include an ethylene vinyl acetate copolymer (EVA) coating or other sealants or heat seal lacquers. Additionally, the material may include a primer and print/color layer.

In the embodiment shown in FIG. 1, the flexible substrate 104 is a two-up roll that is cut to provide the first flexible substrate blank 100 and the second flexible substrate blank 102. In alternate embodiments, a one-up roll that includes only the flexible substrate blank 100 may be utilized. The first flexible substrate blank 100 includes a flap portion or panel 106 attached to a back portion or panel 110 along a fold line 108. The back portion or panel 110, in turn, attaches to a front portion or panel 114 along a fold line 112, and the front portion or panel 114 attaches to a second flap portion 122 along a fold line 124. The second flexible substrate blank 102, similar to the first flexible substrate blank 100, includes a flap portion 116, a back portion 118, a front portion 120 and a second flap portion 126 attached to each other via fold lines 108, 112 and 124, respectively.

The term flexible substrate blank as used herein includes both the substrate in the one-up or two-up roll configurations. The two-up roll configuration may be utilized to manufacture two flexible packages simultaneously. The two simultaneously manufactured flexible packages may, in turn, be separated into individual packages at the end of the process. Alternatively, the flexible substrate blanks may be separated at the beginning of the process and manufactured in a manner similar to the one-up configuration. The term substrate as used herein will include any suitable flexible material, film or paper configured to hold, for example, consumable products. The terms seal or sealed as used herein include all known or contemplated methods and systems for joining or bonding materials. For example, a first material may be joined to itself or to a second material utilizing an ultrasonic sealing process, a heat sealing process such as a impulse sealer, and/or an adhesive sealing process, such as using a cold seal.

FIG. 2 illustrates an enlarged view of the first flexible substrate blank 100. The flexible substrate blank 100 may be printed with graphics, logos, health, ingredient and/or regulatory information as well as colors or patterns such as registration marks 200 and 202, preferably before the blanks are formed, such as by printing the substrate before it is formed into a roll. The registration marks 200 and 202 may be utilized to optically recognize and orient the flexible substrate for separating and thereafter handling blanks 100 during the manufacturing process. For example, the registration marks may be utilized to align and identify physical locations on the flexible substrate blank 100 relative to a heat sealer such as an impulse sealer, an ultrasonic sealer, an adhesive and/or tape applicator, as well as the bending, folding, trimming, cutting or scoring equipment utilized in the manufacturing of a flexible package as disclosed herein. In another embodiment, the flexible substrate may be oriented utilizing physical and/or mechanical alignment techniques.

The flap portion 106 of the flexible substrate blank 100 may include or define a contour line or spline 204. The spline 204 may indicate or represent the shape or configuration of a tab or pull 206 that may be provided or formed to assist a user in opening the flexible package resulting from the manufacturing operations and process described herein. The spline 204 may, in alternate embodiments, represent a graphical boundary printed on the flexible substrate blank 100. Alternatively, the spline 204 may represent a score line, a weakened or frangible portion of a laminate structure and/or an absence of a material or coating arranged to establish a weakness in the structure of the flexible substrate blank 100 to facilitate forming the tab or pull 206. The spline 204 may be cut, trimmed or defined via, for example, a mechanical or laser cutting operation.

The flap portion 106 may further include areas where tamper indicators 210 and 212 may be formed. Each of the tamper indicators 210 and 212, in this embodiment, is arranged and aligned substantially parallel to the peripheral edge PE of the flexible substrate blank 100. The tamper indicators 210 and 212 each respectively include frangible portions or areas 214 and 216. The frangible portions 214 and 216 may intersect with the spline 204 formed in a subsequent or concurrent trimming or cutting operation. As with the spline 204, frangible portions 214 and 216 may represent a score line, a weakened or frangible portion of a laminate structure and/or an absence of a material or coating arranged to establish a weakness in the structure of the flexible substrate blank 100 to facilitate forming the frangible portion 214 and 216.

The second flap portion 122 may include or define a second contour line or second spline 205. The second spline 205 may be configured to mirror the spline 204 about the fold line 112. The front portion 114 attached to the second flap portion 122 along, for example, the fold line 124, may further include side seal areas 218 and 220 defined adjacent to the peripheral edges PE of the flexible substrate blank 100 and between the fold lines 112 and 124. The side seal areas 218 and 220 are aligned and positioned to compliment side seal areas 222 and 224 established adjacent to the peripheral edges PE of the front portion 114.

The front portion 114 may include a score line 226 configured to define an access panel to allow access to the consumable product contained within the package, discussed in more detail below. The score line 226, in one exemplary embodiment, may be formed or aligned adjacent to the fold line 124. In yet another embodiment, the score line 226 may extend through the fold line 124 between the front portion 114 and the second flap portion 122. The score line 226 represents a weakened or frangible portion of a laminate structure and/or an absence of a material or coating arranged to establish a weakness in the structure of the flexible substrate blank 100. The score line 226 may further include a tab or notch 228 configured to facilitate separation of a portion of the substrate material from itself. For example, as a force is applied along the score line 226, the point or tip 229 of the notch 228 serves as a primary point of weakness along the score line 226. Accordingly, a force applied to the score line 226 causes the material to separate beginning at the point or tip 229 and to propagate along the score line. This configuration ensures that the score line 226 may be easily separated and/or opened.

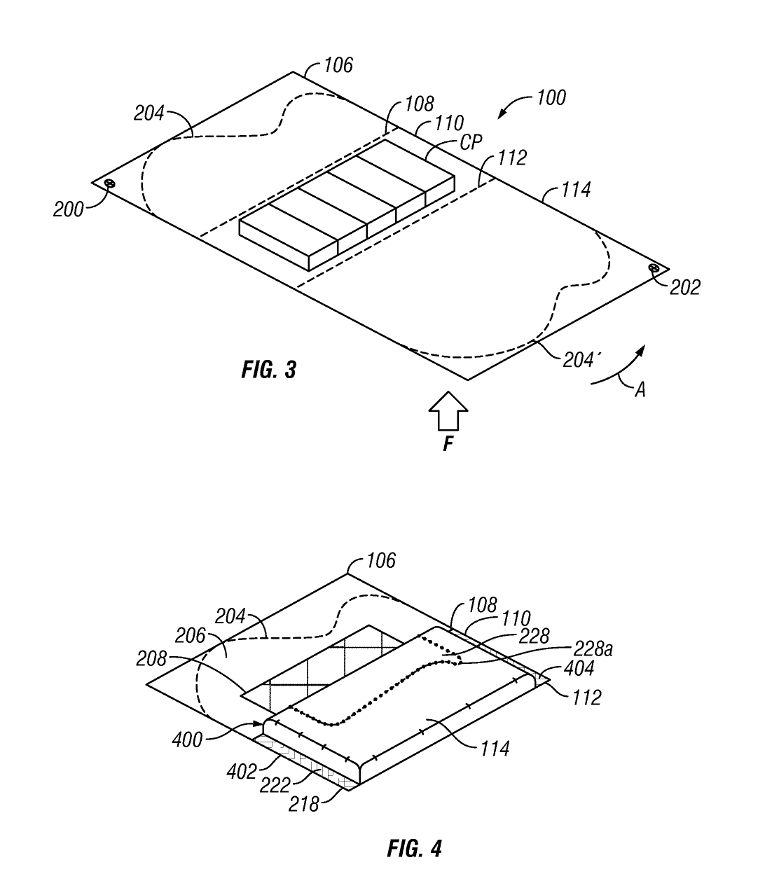

FIGS. 3 and 4 illustrate a plurality of consumable products CP positioned on the substrate blank 100 in a position relative to the registration marks 200 and 202. The consumable products CP may be positioned on the back panel 110 as shown, substantially between the fold lines 108 and 112. Alternatively, the consumable products CP may be positioned on the front portion 114 adjacent to the score line 226. In either event, they will be positioned adjacent to where the score line 226 will end up when the front and back portions are folded together along line 112.

The consumable products CP may be tacked or otherwise affixed in a desired position utilizing, for example, a non-reactive adhesive, wax, hot melt adhesive, cold seal adhesive and/or tape. Once the consumable products CP are positioned correctly, a force F may be applied to the front portion 114 and second flap portion 122. The force F causes the front portion 114 and the second flap portion 122 to bend or fold along the fold line 112. The second flap portion 122 may be folded such that the second spline 205 aligns and engages the spline 204 of the flap portion 106. In another embodiment, the material of the second flap portion 122 may be folded along the fold line 112 to engage the material of the flap portion 106 and the spline 204/205 may be formed during a subsequent cutting or trimming operation. In this way, the front portion 114 may be folded into contact with the consumable products CP. The front portion 114 and the back portion 110 may be joined or sealed along the peripheral edge PE of the substrate blank 100, preferably in the complimentary side seal areas 218, 220 and 222, 224, respectively, to form a pocket 400 as shown in FIG. 4. The seal around the consumable products CP may be provided without adhesive or other additional materials in order to prevent contamination and/or alteration of the consumable products CP.

The second flap portion 122 and the flap portion 106 may further be joined or sealed to define a two-ply or double layered tab or pull 206. As discussed above, the spline 204 and the spline 205 may be preformed and aligned before being sealed together to form the tab or pull 206. Alternatively, the material of the flap portion 106 and the second flap portion 122 may be sealed together to form a two-ply portion and the spline 204/205 may be formed during a subsequent or concurrent cutting or trimming operation. In this way, the tab or pull 206 may be reinforced and/or strengthened to withstand repeated opening and closing of the pocket 400. In another embodiment, the tab or pull 206 may be embossed during, for example, the sealing process to provide additional structural strength.

As described above, the second flap portion 122 and front portion 114, and the flap portion 106 and back portion 110, are joined together. The pocket 400 may thus be sealed to preserve the consumable products CP. Joining the front portion 114 to the back portion 110 and the flap portion 106 to the second flap portion 122 may, in one or more embodiments, involve adhesive, heat or ultrasonic sealing of the seal area 222 to the seal area 218 to form a bonded area 402, and the seal area 224 to the seal area 220 to form a bonded area 404. For example, an impulse sealer may be utilized to direct heat via a spike or wire to join the material of the front portion 114 to the back portion 110 in the marginal areas around the pocket 400. The impulse sealer may clamp the molten material of the front portion 114 to the back portion 110 to allow a seal or bond to form as the material of the flexible substrate blank 100 cools after the directed heat has been removed. The seal areas 222 and 224 may, in another embodiment, be embossed during the sealing process to provide for additional structural strength.

The tab or pull 206 may further be configured to support or carry an adhesive in a closure area 208. For example, a pressure sensitive adhesive, cold sealing adhesive, or other permanent medium may be applied to an inner surface of the tab or pull 206. The adhesive may be applied using a transfer tape. The adhesive forming closure area 208 may, for example, be applied in a pattern to the flexible substrate blank 100 during the manufacture of the flexible substrate 104 before it is formed into a roll. Alternatively, the adhesive and/or transfer tape may be applied after, for example, the flap portion 106 has been joined to the second flap portion 122 to define the tab or pull 206.

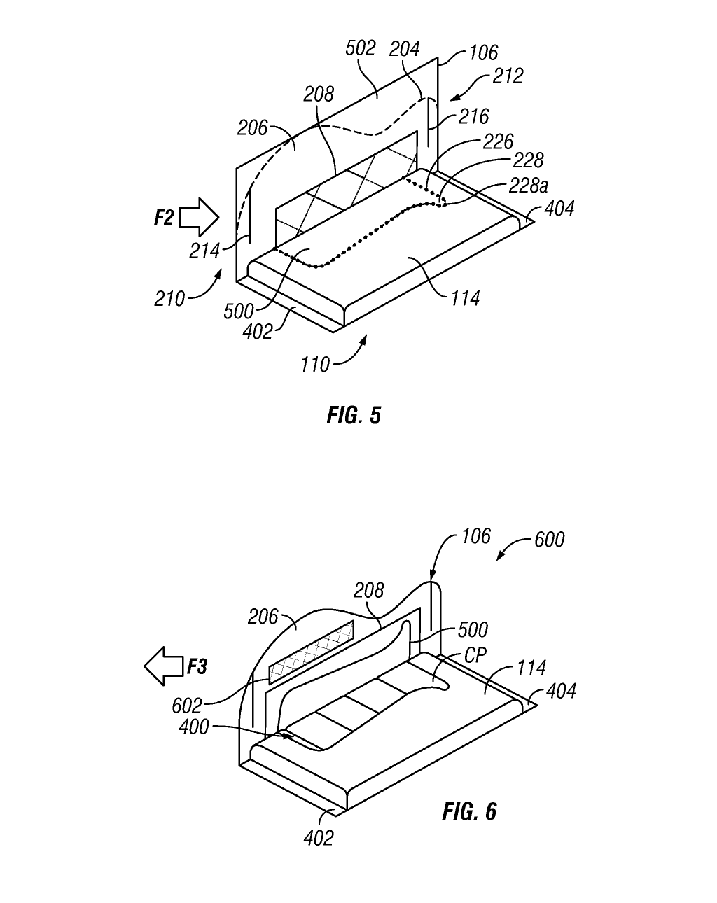

FIG. 5 illustrates the tab or pull 206 formed by the sealed cooperation of the flap portion 106 and the second flap portion 122 folded along the fold line 108 (the fold line 124 aligns and cooperates with the fold line 108) under the influence of force F2. As the tab or pull 206 folds and comes into contact with the front portion 114, the adhesive or closure area 208 may contact and fixedly join to an access panel 500. The access panel 500 may, in one embodiment, be defined by the score line 226 and configured to secure and/or close the pocket 400. Alternatively, the access panel 500 may extend between the score line 226 and the fold line 124 defining the bottom edge of the tab or pull 206. For example, the adhesive or closure area 208 may support transfer tape or other permanent adhesive. In operation, the transfer tape of the adhesive or closure area 208 may engage the access panel 500 such that raising the flap by lifting the tab or pull 206 away from the pocket 400 the first time the package is opened causes the front panel 114 to separate along the score line 226. In this way, the access panel 500 tears away from and separates from the remainder of the front portion 114 and remains fixedly attached to the flap portion 106 to provide access to the consumable products CP contained within the pocket 400.

FIG. 6 illustrates an open flexible package 600 after excess substrate material 502 (see FIG. 5) has been removed along the contour line 204 to define the tab or pull 206. In this embodiment, a force F3 may be applied to the tab or pull 206 to separate the access panel 500 from the front portion 114 to allow access to the consumable products CP contained within the pocket 400. In an embodiment, a recloseable or resealable adhesive 602 may be applied to the tab or pull 206. The tab or pull 206 may, in one embodiment, cooperate with the recloseable or resealable adhesive 602 to allow the pocket 400 to be alternately closed and opened by a consumer. For example, the recloseable or resealable adhesive 602 may be affixed to the tab or pull 206 substantially above or adjacent to the closure area 208 so that it will engage the outer surface of the pocket in a resealable manner. The recloseable or resealable adhesive 602 may be a pressure sensitive adhesive (PSA) or a cold seal adhesive, and may be applied by a transfer tape.

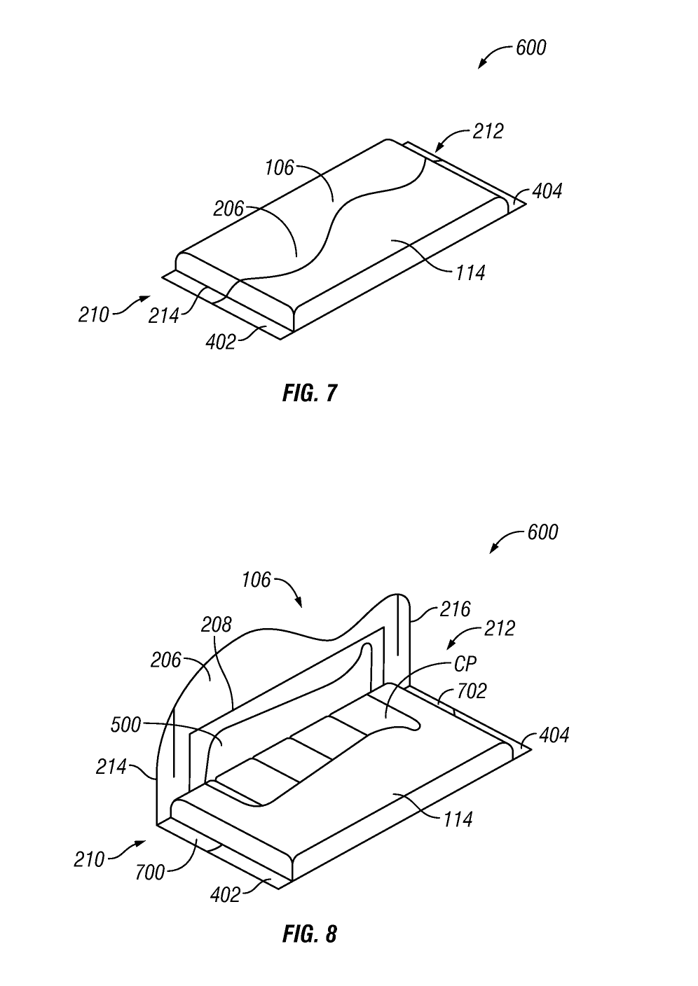

FIGS. 7 and 8 illustrate embodiments of the flexible package 600 showing the tamper indicators 210 and 212 have been sealingly engaged or coupled to the bonded area 402 and 404, respectively. For example, the tamper indicators 210 and 212 may be permanently bonded or attached to the bonded area 402 and 404 utilizing a heat or ultrasonic sealer and/or a permanent adhesive. In response to the force F3 applied to the tab or pull 206, the tamper indicators 210 and 212 may tear or separate along each of the frangible portions or areas 214 and 216. The tamper indicators 210 and 212 are not resealable or recloseable and provide a visual indication that the flexible package 600 has been opened. The tamper indicators 210 and 212 preferable further provide an audible indication as the material of flexible substrate blank 100 separates in response to the force F3 (see FIG. 6). Residual portions 700 and 702 may remain in fixed or permanent contact with the bonded areas 402 and 404, respectively, to provide an addition visual indication. In this way, the flexible package 600 may provide a tamper indication as well as seal and protect consumable products CP in a compact and environmental friendly manner.

As discussed above and illustrated in FIG. 5, a trimming and/or cutting process may be employed to remove excess material 502 from the tab or pull 206 and/or material from along the peripheral edge PE adjacent to the pocket 400 and the bonded areas 402 and 404.

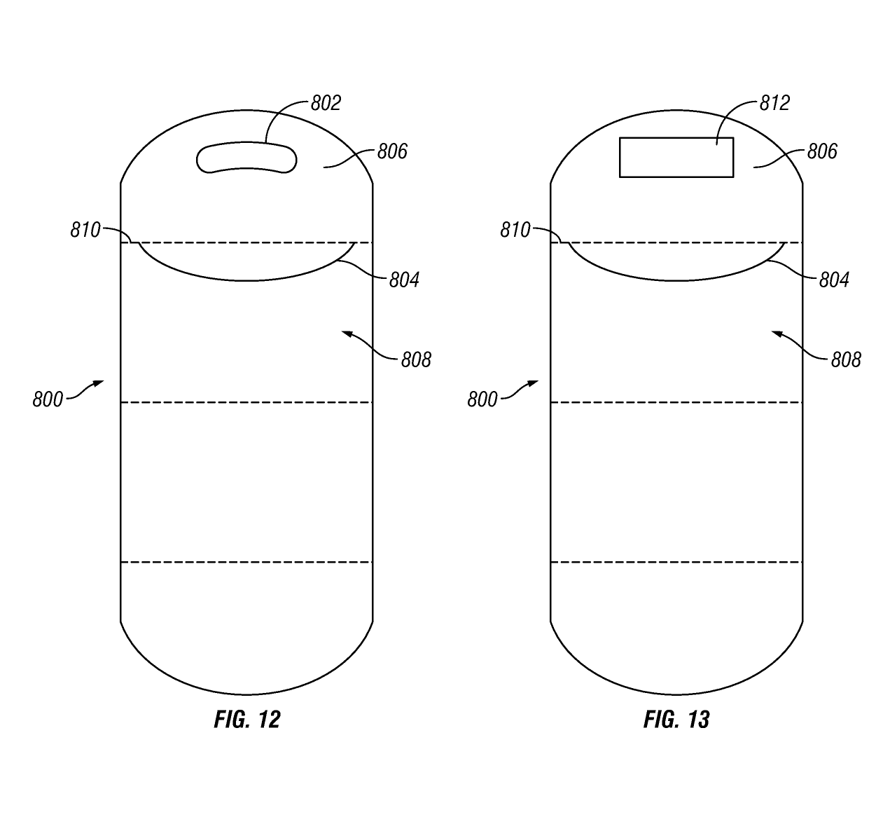

FIGS. 12 and 13 illustrate embodiments of the flexible substrate blank 800 showing a cutout or window 802 on the flap portion or panel 806. The cutout or window 802 may be of any size. The cutout or window 802 is so that a piece of tape 812 can be placed covering the cutout or window 802. The tape 812 may be a single sided tape with resealable adhesive to to allow a flexible package made from the flexible substrate blank 800 to be alternately closed and opened by a consumer. The tape 812 portion peeking through the cutout or window 802 may cooperate to reseal to the front portion or panel 808 by adhesive. The tape 812 may be placed on the inner surface of the flap portion 806. The cutout or window 802 may be located on the flap portion or panel 806 to reseal to an area or portion outside of the score line 804 on the front portion 808 and the fold line 810 between the flap portion 806 and front portion 808. The cutout or window 802 may be in any shape and size.

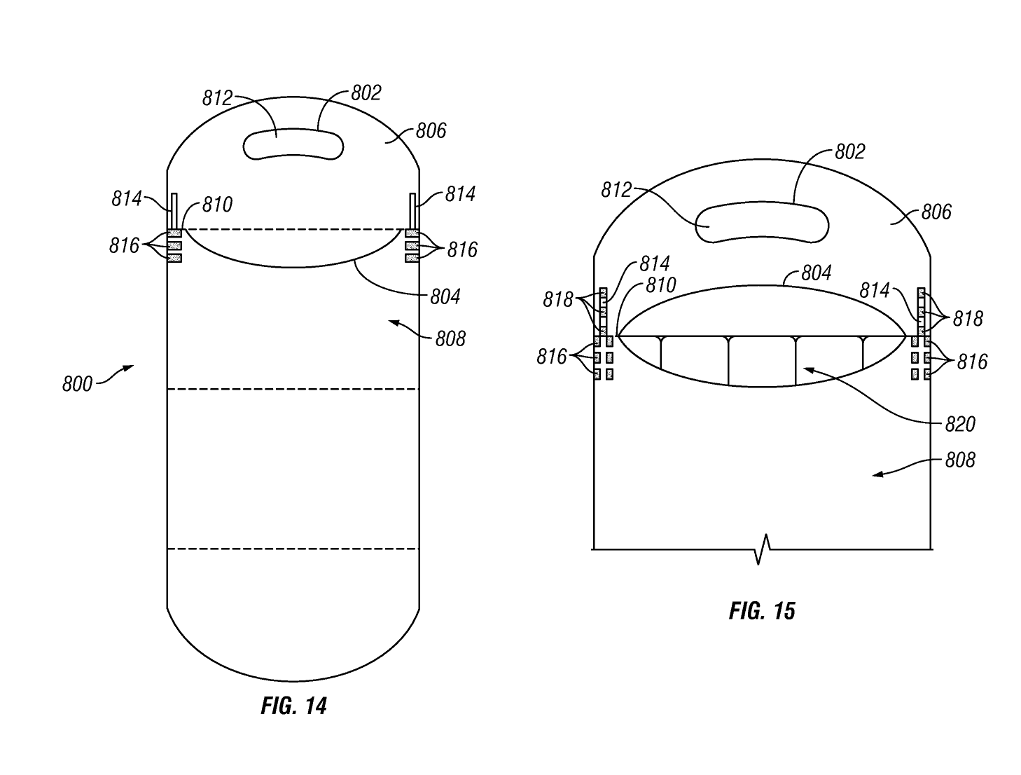

FIGS. 14 and 15 illustrate the outer surface of the flexible substrate blank 800 shown in FIG. 12 including a tamper indicator. The substrate may include print/color on a metalized film wherein primer is between the print and the metalized film and a sealant layer on the outside of the print/color. On the sides of the front portion or panel 808 may include one or more non-primer areas 816. On the sides of the flap portion or panel 806 may include sealant/adhesive areas 814. The cooperation of the sealant/adhesive areas 808 and non-primer areas 816 together form a tamper indicator. The sealant/adhesive area 814 and non-primer areas 816 may be sealed together through heat sealing or ultrasonic sealing. When the flap portion 806 is lifted for the first time to access any consumable products 820 in the flexible package, the print/color and sealant layer may delaminate in the non-primer area 816 so that the metalized layer appears and the delaminated print/color and sealant layer 818 portions are bonded to the sealant/adhesive 814 on the flap portion or panel 806. The difference in color between the portions of the non-primer area that was delaminated may indicate to consumers of tamper evidence. The non-primer area may be on the flap portion 806 and the sealant/adhesive areas may be on the front portion 808. If there are several (3 or more) non-primer areas 816, an audible sound can be made (like a zipper), further indicating that the package has not been tampered with.

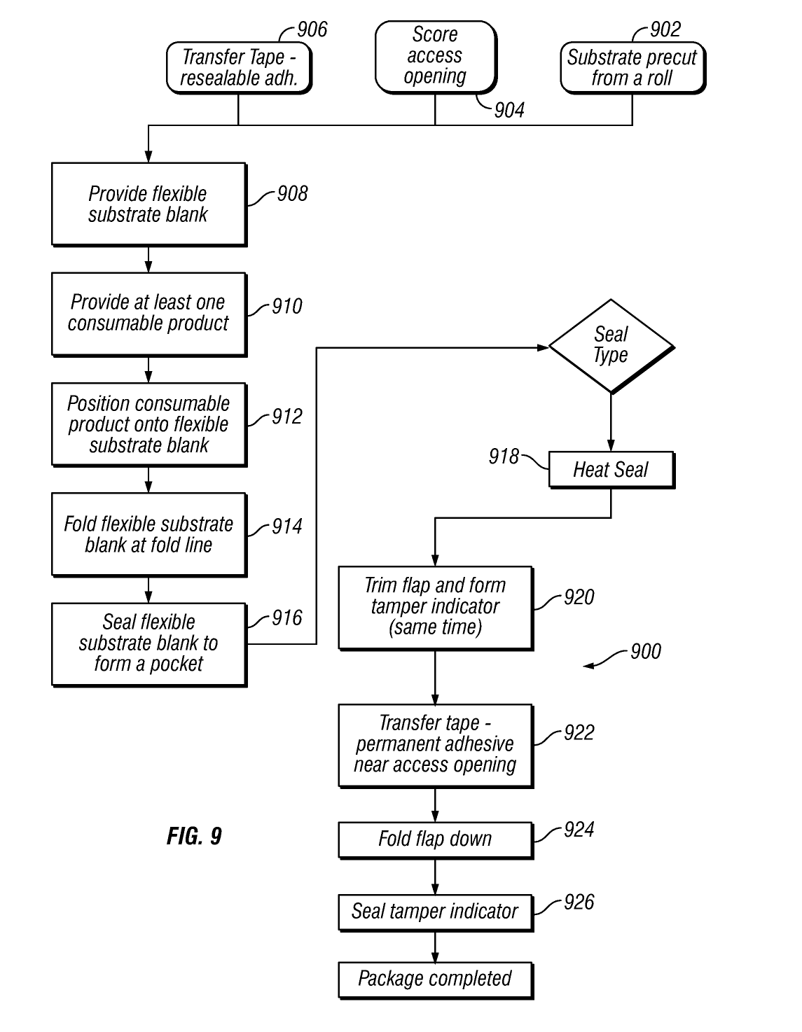

FIGS. 9 to 11 detail process steps, elements and configurations which may be combined to manufacture an exemplary flexible package 600. In the flow charts, regular rectangular boxes represent individual steps, and diamond shape box represents a decision point. The arrows represent a sequential flow of steps. Some boxes are connected by double headed arrows, reflecting that the process steps can be performed in either order or simultaneously. Rectangular boxes with rounded corners represent alternatives and steps that may be optionally performed. For example, the rectangular boxes with rounded corners along the top portion of the figures represent alternatives and optional steps while the flexible substrate is in a continuous sheet or before it is delivered to the package manufacturing location. In addition to the different box shapes, it should be noted that there are alternatives to the exemplary steps shown in the figures. For example, one or more of the adhesion steps disclosed and discussed in the exemplary processes may be utilized in place of one or more sealing or joining steps. Similarly, the exemplary manufacturing processes may interchangeably utilize and incorporate trimming, cutting and scoring steps in the manufacture of the flexible package.

FIG. 9 is a flow chart 900 illustrating an exemplary process that may be utilized to manufacture the flexible package 600. At step 902, the roll of flexible substrate 104 may be prepared by precutting or forming the flexible substrate blanks 100 from the base material. At step 904, the score line 226 for eventually forming the access opening may be formed or cut into the material of the flexible substrate blank 100 at a position relative to the registration marks 200, 202. At step 906, transfer tape may be applied, for example, to provide resealable adhesive 602.

The preprocessing steps 902 to 906 may be conducted in an in-line or off-line manner based on the specific needs and/or requirements of the manufacturing process. Additionally during the preprocessing steps, non-primer area(s) and sealant area(s) may be formed. The result is that at step 908, the flexible substrate blank 100 is provided, in either a one-up or two-up format. At step 910, the consumable products CP are provided for sealing within the flexible package 600. At step 912, the consumable products CP is positioned on the back or front portions 110, 114, respectively, of the flexible substrate blank 100 and optionally secured and/or taped into position.

At step 914, the second flap portion 122 is folded in cooperation with the front portion 114 along the fold line 112 to engage the flap portion 106 and the back portion 110 to form a two-ply tab or pull 206. In one embodiment, the score lines 204 and 205 may be aligned as the second flap portion 122 comes into contact with the flap portion 106.

At step 916, the front portion 114 is sealed or otherwise joined to the back portion 110 at bonded areas 402 and 404. In this way, the front portion 114 and the back portion 110 cooperate to define the pocket 400. The pocket 400 contains and protects the consumable products CP between the front portion 114 and the back portion 110. At step 918, the seal is established between the marginal areas of the front portion 114 and the back portion 110, such as by utilizing a heat sealing technique and/or equipment, or a cold seal. At the same time, if a second flap portion 122 is included on the substrate blank 100, the second flap portion 122 is sealed to the flap portion 106.

At step 920, the excess material 502 may be trimmed or otherwise removed from the two-ply tab or pull 206. Additional material may be further trimmed from the peripheral edge PE adjacent to the pocket 400.

At step 922, a second transfer tape 602 (see FIG. 6) may be applied and/or affixed to the tab or pull 206 area adjacent to the closure area 208. The second transfer tape provides a recloseable or resealable adhesive 602 configured to allow the tab or pull 206 to be opened and closed to allow access to the consumable products CP in the pocket 400. At step 924, the tab or pull 206 may be folded along the fold line 108 to bring the adhesive 602 into contact with the surface of the pocket 400, as well as seal the closure area 208 to the access panel 500.

At step 926, the tamper indicators 210 and 212 are formed by ultrasonic and/or heat sealing the tab or pull 206 to the marginal areas of the outer surface of the front portion on the side of the pocket 400 to form the bonded area 402 and 404 adjacent to the frangible portions 214 and 218, respectively, resulting in a completed package, ready for distribution.

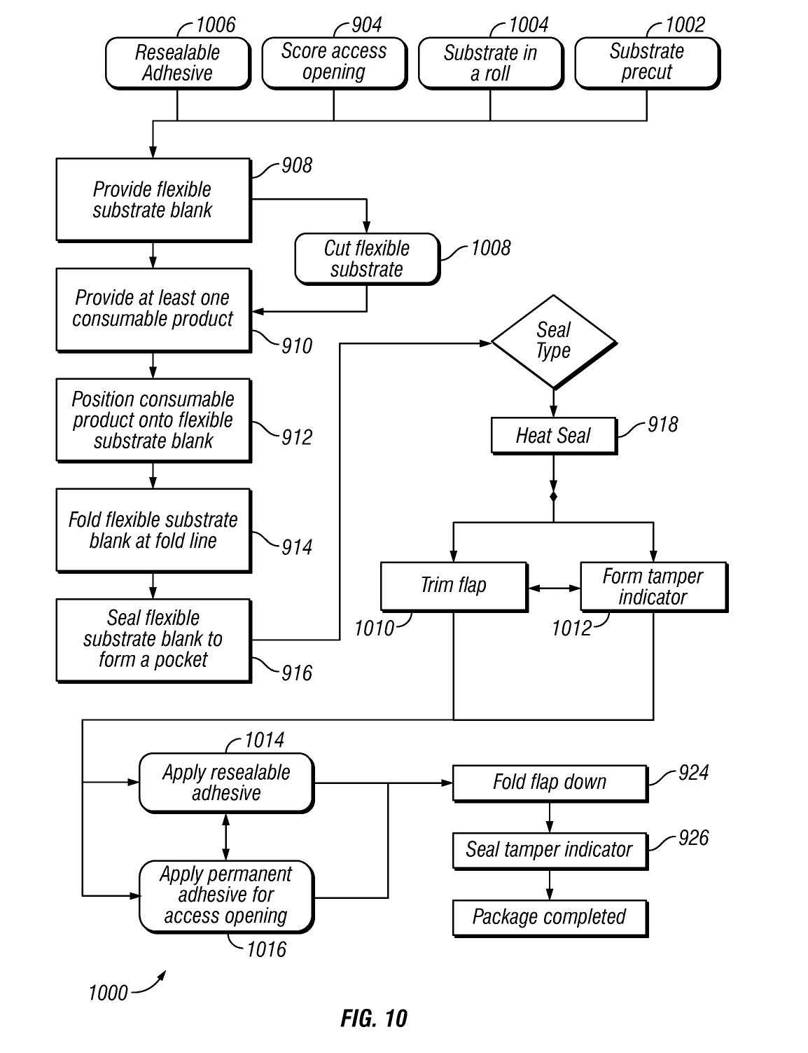

FIG. 10 is a flow chart 1000 illustrating an exemplary process that may be utilized on more of a commercial scale to manufacture the flexible package 600. The exemplary process shown in flow chart 1000 shares many common steps and/or elements with the process discussed in connection with the process shown in flow chart 900. Like elements and step have been labeled utilizing common reference numerals.

At step 1002, the flexible substrate material may be prepared by precutting or forming to provide the desired features, folds and/or score lines. At step 1004, the precut flexible substrate material may be wound or otherwise formed into the roll of flexible substrate 104 for delivery to the package manufacturing facility. Alternatively, if blanks are already cut from a roll of substrate, at step 904, the score line 226 may be formed or cut into the material of the flexible substrate blank 100 at a position relative to the registration marks 200, 202. At step 1006, a resealable adhesive may be applied to, for example, the front portion 114 in a position determined to cooperate with the score line 226 when the flexible package 600 is assembled as discussed above.

As with the process of FIG. 9, the preprocessing steps 904, 1002, 1004 and 1006 may be conducted in an in-line or off-line manner based on the specific needs and/or requirements of the manufacturing process. The result is that at step 908, the flexible substrate blank 100 is provided, in either a one-up or two-up format. If it is provided in a two-up format, at step 1008, the flexible substrate material may be cut to create individual flexible substrate blanks 100. (Of course, the two-up format blanks could be left together and separated at the end of the process.) At step 910, the consumable products CP are provided for sealing within the flexible package 600. At step 912, the consumable products CP are positioned on the back or front portions 110, 114 of the flexible substrate blank 100 and optionally secured into position to ensure proper alignment with the registration marks 200, 202 is maintained.

At step 914, the second flap portion 122 may be folded in cooperation with the front portion 114 along the fold line 112 to engage the flap portion 106 and the back portion 110 to form a two-ply tab or pull 206. In one embodiment, the score lines 204 and 205 may be aligned as the second flap portion 122 comes into contact with the flap portion 106.

At step 916, the front portion 114 may be sealed or otherwise joined to the back portion 110 at bonded areas 402 and 404. In this way, the front portion 114 and the back portion 110 cooperate to define the pocket 400. The pocket 400 contains and protects the consumable products CP between the front portion 114 and the back portion 110. At step 918, the seal may be established between the front portion 114 and the back portion 110, such as by utilizing a heat sealing technique and/or equipment.

At step 1010, the excess material 502 may be trimmed or otherwise removed from the two-ply tab or pull 206. Additional material may be further trimmed from the peripheral edge PE adjacent to the pocket 400.

At step 1012, the frangible portions or area 214 and 216 may be formed in the tab or pull 206. The frangible portions 214 and 216 may be formed by, for example, scoring the material of the tab or pull 206 and/or defining a weakened area by limiting where an over or protective coating is applied to the surface of the substrate material. The trimming and forming operations may be performed sequentially or simultaneously in accordance with the process configuration and/or requirements.

At steps 1014 and 1016, a resealable adhesive and a permanent adhesive may be applied to the surface of the tab or pull 206. For example, at step 1014 (if not already provided in step 1006) a resealable or recloseable adhesive may be applied to tab or pull 206 at a location determined to cooperate with the surface of the pocket 400. Similarly, at step 1016, a permanent adhesive seal may be applied at the closure area 208 in order to engage the access panel 500. In this way, the opening or removal of the tab or pull 206 from the surface of the pocket 400 causes the permanent adhesive to separate the access panel 500 along the score line 226 to open the pocket 400 and provide access to the consumable products CP. By pushing the tab or pull 206 into contact with the surface of the pocket 400, the resealable adhesive may removably reattach to or close the pocket 400.

At step 924, the tab or pull 206 may be folded along the fold line 108 to bring the surface of tab or pull 206 into resealable or recloseable contact with the surface of the pocket 400.

At step 926, the tamper indicators 210 and 212 may be formed by heat sealing the flap portion 106 to the marginal areas to form the bonded area 402 and 404 adjacent to the frangible portions 214 and 218, respectively.

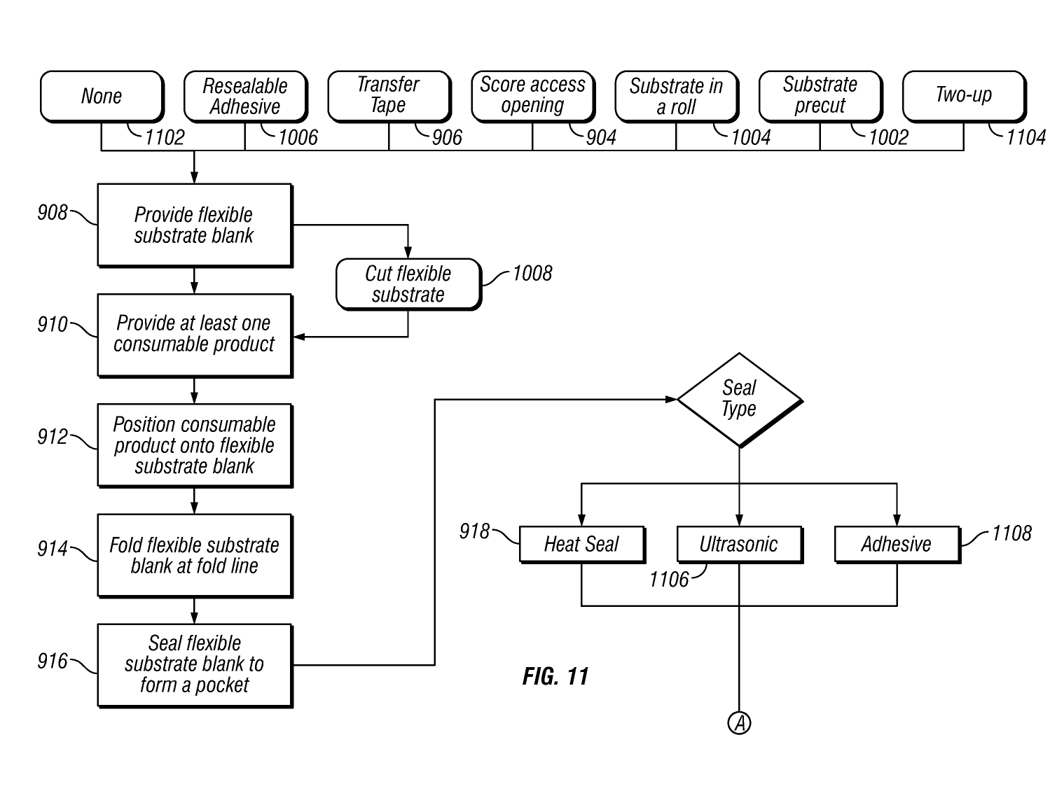

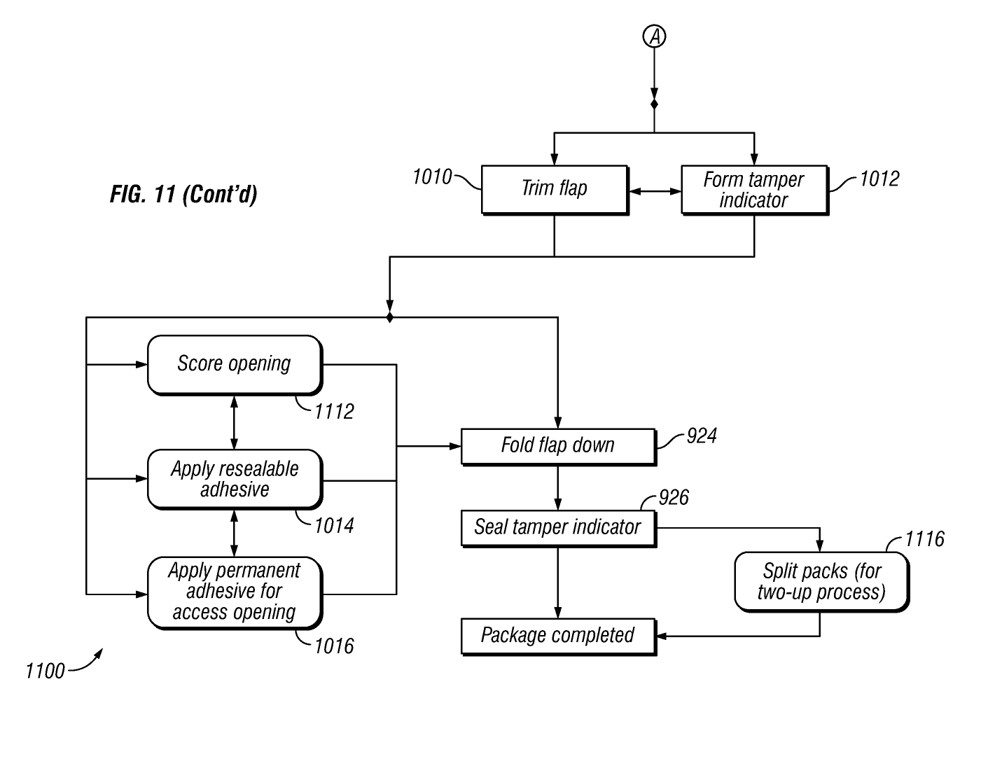

FIG. 11 is an alternate flow chart 1100 illustrating other process embodiments and/or alternatives that may be utilized to manufacture the flexible package 600. The exemplary process shown in flow chart 1100 shares many common steps and/or elements with the process discussed in connection with the process shown in flow charts 900 and 1000 shown in FIGS. 9 and 10, respectively. Like elements and step have been labeled utilizing common reference numerals.

Steps 904, 906 and 1002 to 1006 disclose, as previously discussed, alternate steps or tasks that may be implemented. Steps 1102 and 1104 signify preprocessing decisions implemented prior to the manufacture of the flexible package 600. At step 1102, the raw base material for the flexible package 600 may be utilized without enhancements or alterations. At step 1104, the roll of flexible access material 104 may be prepared or configured to provide the flexible substrate blanks 100 and 102 in a two-up configuration for side-by-side processing.

At steps 1106 to 1110, alternate sealing or heat sealing devices and/or processes may be utilized in connection with, or in place of, the heat sealing process discussed in step 918. For example, at step 1106, an ultrasonic sealing process may be utilized to seal the front portion 114 to the flap portion 106. At step 1108, an adhesive may be utilized to seal the front portion 114 to the tab or pull 206. One example of such an adhesive is a cold seal.

At step 1112, the score line 226 may be formed or cut into the material of the flexible substrate blank 100 at a position relative to the pocket 400, such as with a laser, if the score line had not been formed earlier at step 904. It is noted that the box for step 1112 has rounded corners, indicating that this is an alternative step. Likewise, the boxes for steps 1014 and 1016 (which are not described here since they are the same steps as described in conjunction with FIG. 10) also have rounded corners, indicating that in the flow chart 1100 of FIG. 11 these are alternative steps, not used if the transfer tape with a permanent adhesive was applied to the flexible substrate earlier at step 906 and if the releasable adhesive was applied earlier at 1006.

At set 1116, after a pair of flexible packages 600 have been formed, the flexible substrate material (e.g., the material comprising flexible substrate blank 100 and flexible substrate 102) may be separated or split to divide the individual packages.

If the substrate includes a colored film on a metalized layer, the frangible seal used to make the tamper evident areas may delaminate so that the metalized layer appears, which will contrast with the color of the remainder of the flap portion. Also, it is preferable if the first time that the score line 204 separates, an audible sound is made, further indicating that the product has not been tampered with.

It should be understood that various changes and modifications to the presently preferred embodiments described herein will be apparent to those skilled in the art. The adhesive shown in closure area 208 could be applied to the area inside score line 226. Likewise, the adhesive 602 could be applied to the front portion 114. If the score line 226 is sufficiently frangible, one type of adhesive could be used for both adhesive 602 and closure area 208, so long as the adhesive was strong enough to open the access panel 500 when the package 600 is opened for the first time, but allow releasable sealing between the flap 106 and the front portion 114. This may also be accomplished if a layer of adhesive is applied to both the area 208 and the front of access panel 500. Instead of using an adhesive in closure area 208, an impulse heat sealing might also be used to permanently seal the flap 106 to the access panel. While the fold lines 108 and 112 are preferably parallel, they do not necessarily have to be if other changes are made to the package configuration. Such changes and modifications can be made without departing from the spirit and scope of the present invention and without diminishing its intended advantages. It is therefore intended that such changes and modifications be covered by the appended claims.

1. A resealable package configured to contain a consumable product, the package comprising:
a) a flexible substrate blank having a flap portion, a back portion and a front portion, wherein the flap portion, the back portion and the front portion are contiguously formed portions of the flexible substrate blank;
b) a pocket formed by the cooperation of an inner surface of the front portion and an inner surface of the back portion along a first fold line; and
c) a tamper indicator formed by the cooperation of an inner surface of the flap portion and the outer surface of the front portion on the side of the pocket when the flap portion engages the pocket after being folded along a second fold line.

2. The package of claim 1 further comprising a score line provided in the front portion to define an access panel.

3. The package of claim 2 wherein the score line is configured to cooperate with the front portion and the flap portion to provide said access panel.

4. The package of claim 1 wherein the tamper indicator comprises at least one frangible portion provided by a score line in the flap portion.

5. The package of claim 1 wherein the tamper indicator comprises a weakened area of the flap portion formed substantially parallel to a peripheral edge of the pocket.

6. The package of claim 1 wherein the pocket is formed by a seal formed between the front portion and the back portion.

7. The package of claim 6 wherein the seal is a seal selected from the group consisting of: an ultrasonic seal; a heat seal and an adhesive seal.

8. The package of claim 1 wherein the tamper indicator comprises at least one non-primer area and sealant area.

9. The package of claim 1 wherein the flap portion engages the outer surface of the pocket in a resealable manner utilizing an adhesive carried by the flap portion.

10. The package of claim 2 wherein the flap portion further comprises a permanent adhesive between the flap portion and the front portion in the area of the access panel.

11. The package of claim 1 wherein the flap portion comprises a cutout and tape covering the cutout.

12. A method of manufacturing a resealable package configured to contain a consumable product, the method comprising:
a) providing a flexible substrate blank having a flap portion, a back portion and a front portion, wherein the flap portion, the back portion and the front portion are contiguously formed portions of the flexible substrate blank;
b) positioning at least one consumable product on an inner surface of the substrate blank such that the at least one consumable product is substantially adjacent to a score line that provides an access panel formed in the front portion;
c) folding the front portion along a first fold line such that the front portion engages the back portion along at least one peripheral edge of the substrate blank;
d) sealing the front portion to the back portion along said peripheral edge to form at least one pocket, wherein the pocket contains the at least one consumable product; and
e) folding the flap portion along a second fold line such that the flap portion engages an outer surface of the pocket, with at least one side section of the flap portion being substantially adjacent to the at least one peripheral edge.

13. The method of claim 12 further comprising forming a tamper indicator between the inner surface of the flap portion and the outer surface of the front portion on the side of the pocket.

14. The method of claim 12 further comprising applying a permanent adhesive between the flap portion and the front portion in the area of the access panel.

15. The method of claim 12 further comprising trimming the flexible substrate blank adjacent to the at least one peripheral edge.

16. The method of claim 13 wherein forming the tamper indicator further comprises forming at least one frangible portion provided by a score line in the flap portion.

17. The method of claim 13 wherein forming the tamper indicator further comprises forming a weakened area in the flap portion.

18. The method of claim 13 wherein forming the tamper indicator further comprises forming a non-primer area and sealant area.

19. The method of claim 18 wherein the flap portion engages the outer surface of the pocket utilizing a pressure sensitive adhesive.

20. The method of claim 12 wherein sealing the front portion to the back portion to form the pocket includes sealing the front portion and the back portion along the at least one peripheral edge.

21. The method of claim 20 wherein the seal is a seal selected from the group consisting of: an ultrasonic seal; a heat seal and an adhesive seal.

22. The method of claim 12 further comprising forming a notch in the score line, wherein the notch is configured to concentrate parting forces on the score line such that raising the flap away from the pocket the first time the package is opened causes the front panel to separate along the score line.

23. The method of claim 12 wherein the consumable product is positioned in step b) on an inner surface of the back portion.

24. The method of claim 12 wherein the flexible substrate blank further having a cutout.

25. The method of claim 24 further comprising covering the cutout with tape.
